(19) United States
(12) Patent Application Publication
(10) Pub. No.: US 2019/0266891 A1
(43) Pub. Date: Aug. 29, 2019

(54) A METHOD TO QUANTITATIVELY ANALYZE THE EFFECTS OF URBAN BUILT ENVIRONMENT ON ROAD TRAVEL TIME

(71) Applicant: DALIAN UNIVERSITY OF TECHNOLOGY, Dalian City, Liaoning Province (CN)

(72) Inventors: Shaopeng ZHONG, Dalian City, Liaoning Province (CN); Zhong WANG, Dalian City, Liaoning Province (CN); Quanzhi WANG, Dalian City, Liaoning Province (CN); Yanquan ZOU, Dalian City, Liaoning Province (CN); Rong CHENG, Dalian City, Liaoning Province (CN); Xufeng LI, Dalian City, Liaoning Province (CN)

(21) Appl. No.: 16/309,770

(22) PCT Filed: Apr. 18, 2018
(86) PCT No.: PCT/CN2018/083443

§ 371 Date: Mar. 12, 2019

(30) Foreign Application Priority Data
May 24, 2017 (CN) 201710371007.8

(51) Int. Cl. G08G 1/01; G08G 1/052; G06F 17/18

(52) U.S. Cl. CPC G08G 1/0129; G06F 17/18; G08G 1/052; G08G 1/0112

(57) ABSTRACT

The invention belongs to the research technology field of urban transportation planning and traffic big data, and provides a method to quantitatively analyze the impact of urban built environment on road travel time. Firstly, the average speed and the built environment attribute information of each small road section are extracted, based on the taxi GPS data and the spatial geographic information data on the research route. Then, taking the average speed of each small section as the dependent variable, the built environment attribute of the road section is used as the key independent variable, and the virtual variable of the nearest intersection type of the road section is used as the adjustment variable. The regression analysis is carried out with considering the interaction between the key independent variable and the adjustment variable, and the key independent variables which significantly affect the average speed of the road sections are selected from the obtained regression results. Finally, the extracted key independent variables are brought into the geographic weighted regression model for quantitative analysis. The effect and benefit of the invention is to provide decision-making basis for transportation planning and management departments to adjust urban built environment attributes and improve road network operation efficiency.

### TECHNICAL FIELD

The invention belongs to the research field of urban transportation planning and traffic big data, particularly relating to the application of urban taxi Global Positioning System (GPS) data and spatial geographic information data to study the effects of urban built environment on road travel time.

### TECHNICAL BACKGROUND

In recent years, with more awareness of travel time and the deterioration of transportation network efficiency, the study on road travel time estimation has attracted more and more attention in the field of intelligent transport system. Most of the existing works on road travel time estimation are based on traffic flow theory or data-driven method. For example, Hofleitner A proposes a hybrid model framework to estimate the mainline travel time with a large number of floating car GPS data in “Arterial travel time forecast with streaming data: A hybrid approach of flow modeling and machine learning”; Mucsi K uses the sparse data collected by the floating car to predict the three-layer neural network of the travel time of the whole road section in “An Adaptive Neuro-Fuzzy Inference System for estimating the number of vehicles for queue management at signalized intersections”; In “Estimation of link travel time based on low frequency sampling GPS data”, Ma Chaofeng focuses on the influence of intersections based on traffic flow theory, and uses the low-frequency GPS data to study the travel time of the road section to improve the estimation accuracy.

However, these methods rarely analyze the main factors affecting the road travel time, and are limited by the built environment attributes and data of the research area itself, so the research results are difficult to be directly applied to other regions. Previous studies have confirmed that there is a close relationship between urban built environment and travel behaviors of the travelers. Urban built environment will affect travelers' travel destination, travel mode, travel frequency, travel route, and ultimately affect the road network travel time. Therefore, it is necessary to deeply study the main factors affecting the travel time of the road from the perspective of urban built environment. In addition, due to the existence of spatial heterogeneity, the influence of urban built environment on road travel time in different regions is also different. In view of these facts, the invention proposes a method to quantitatively analyze the effects of urban built environment on road travel time based on urban taxi GPS data and spatial geographic data.

### CONTENT OF THE INVENTION

The technical problem to be solved by the invention is: Firstly, the research road is divided into several small road sections and the average speed and built environment attribute information of each small road section are extracted based on the taxi GPS data and spatial geographic information data of the research road. Then, taking the average speed of each small road section as the dependent variable, the built environment attribute of the road section is used as the key independent variable, and the virtual variable of the nearest intersection type of the road section is used as the adjustment variable. Regression analysis is carried out with considering the interaction between the key independent variable and the adjustment variable, and the key independent variables which significantly affect the average speed of the road section are selected from the obtained regression result. Finally, the extracted key independent variables are brought into the Geographic Weighted Regression (GWR) model for quantitative analysis.

### Technical Solution of the Invention

A method to quantitatively analyze the effects of urban built environment on road travel time, the steps are as follows:

1. Basic Data

The selected research road (8 kilometers or more) is divided into small road sections, with each road section of 20 to 30 meters.

(1) Data extraction of average speed of road section and the rate of occupied taxi According to the road sections and time periods to be studied, the GPS data of the collected taxis are filtered, corrected, and matched. The GPS data of the taxis containing the speed and passenger status of each road section are obtained, which is recorded as table a. Then, according to the taxi GPS data in Table a, we can calculate the average speed and passenger ratio of all taxis in each section (that is the ratio of number of taxis with passengers to the total number of taxis).

(2) Extraction of built environmental attributes of road sections Based on the geographic information data of the road network, firstly, the number of buildings, banks, hotels, pharmacies, parking lots, supermarkets, restaurants, bus stations, and schools within 500 meters around the road section is statistically studied. Then, the distance from the nearest school, the nearest intersection, and the nearest bus stop is counted. Finally, the speed limit of each road section is counted.

(3) Classification of Road Intersection Types

All intersections on the study road are independently classified into n (n>=2) types according to the number of imported lanes, whether there is a left-turn lane, and whether the left-turn lane is independent. Then the last type of intersection (i.e. type n) is used as the reference item, and the remaining n−1 types of intersections are set to “dummy variables”, as shown in Table 1:

TABLE 1
Setting of the intersection type dummy variables

| Intersection types | D₁ | D₂ | . . . | Dₙ₋₁ |
|---|---|---|---|---|
| Type 1 | 1 | 0 | . . . | 0 |
| Type 2 | 0 | 1 | . . . | 0 |
| . . . | . . . | . . . | . . . | . . . |
| Type n − 1 | 0 | 0 | . . . | 1 |

2. Global Regression Analysis with Cross Terms

In the global regression analysis, we take the average speed of each road section as the dependent variable, the built environment attribute of the road section as the key independent variable, and the virtual intersection of the nearest intersection type of the road section as the adjustment variable. Meanwhile, we consider the interaction between the key independent variables and the adjustment variables. The specific model structure is as follows,

$$S = {β}_{o} + {\sum }_{k = 1}^{14} {β}_{k} {χ}_{k} + {\sum }_{p = 1}^{n - 1} {η}_{p} {D}_{p} + {\sum }_{k = 1}^{14} {\sum }_{p = 1}^{n - 1} {λ}_{kp} {χ}_{k} {D}_{p} + ɛ$$

where S represents the average speed of the road section; βₒ is the regression constant; [symbol] ₁, [symbol] ₂, . . . , [symbol] ₁₄ respectively indicate the number of buildings, the number of banks, the number of hotels, the number of pharmacies, the number of parking lots, the number of supermarkets, the number of restaurants, the number of bus stops, the rate of occupied taxi, the number of schools, the distance from the nearest school, the distance from the nearest intersection, the distance from the nearest bus stop, and the speed limit, a total of 14 key independent variables; β₁, β₂, . . . , β₁₄ represent the regression coefficients corresponding to [symbol] ₁, [symbol] ₂, . . . , [symbol] ₁₄; D₁, D₂, . . . , Dₙ₋₁ represent virtual variables of n−1 intersection types respectively; η₁, η₂, . . . , ηₙ₋₁ represent the regression coefficients corresponding to D₁, D₂, . . . , Dₙ₋₁; λₖₚ is the interaction coefficient of the built environment attribute and virtual variable of the intersection type; ε is a random error term.

Through global regression analysis, the key independent variables which significantly affect the road travel time can be obtained, and the existence of spatial heterogeneity can be proved. Therefore, the local model needs to be used for further quantitative analysis.

3. Local Model for Spatial Analysis

The key independent variables which significantly affect the road travel time and obtained from the global regression analysis are brought into the local model, namely the geographically weighted regression model (GWR model). The specific model structure is as follows,

$${S}_{i} = {β}_{o} ( {u}_{i} , {v}_{i} ) + {\sum }_{k = 1}^{m} {β}_{k} ( {u}_{i} , {v}_{i} ) {x}_{ik} + {ɛ}_{i}$$

where Sᵢ means the average speed of road section i; ( [symbol] ᵢ, [symbol] ᵢ) is the coordinate of road section i; βₒ( [symbol] ᵢ, [symbol] ᵢ) is a constant of road section i; [symbol] ᵢₖ represents the [symbol] ^{th} independent variable associated with road section i; βₖ( [symbol] ᵢ, [symbol] ᵢ) is the regression coefficient corresponding to [symbol] ᵢₖ; m is the number of independent variables which are statistically significant in the global regression model; εᵢ is the random error of road section i.

The local model considers the spatial heterogeneity of the influence of urban built environment attributes on road travel time in different geographical locations, and studies the phenomenon and causes of this spatial heterogeneity from a quantitative perspective, thus revealing the inherent relationship between urban built environment and road travel time.

### Advantageous Effects of the Invention

The invention analyzes the influencing factors of road travel time from the root, so the obtained results can reflect a more general law, which is easy to be popularized and applied to other research areas; the results of the invention can be used to study the influence law of road sections in different regions of the route. Therefore, it can help traffic managers to identify the location of problems in the urban road network, and then make targeted design schemes to improve the performance of the traffic system. The results of the invention also help the traffic planners and managers to improve their understanding of the relationship between urban built environment and transportation system, thereby formulating targeted urban planning and management strategies, with a view to improving urban built environment, thereby improving the efficiency of the road network at the root and reducing traffic congestion and road travel time.

### ILLUSTRATION OF THE APPENDED DRAWINGS

FIG. 1 shows the location of the road intersections.

FIG. 2 illustrates the spatial distribution of regression coefficients for the number of bus stops.

FIG. 3 displays the spatial distribution of the t value of the number of bus stops.

FIG. 4 demonstrates the spatial distribution of regression coefficients for the distance from the nearest intersection.

FIG. 5 is the spatial distribution of the t value of the distance from the nearest intersection.

### SPECIFIC IMPLEMENTATION METHOD

The specific implementation method of the invention is described in detail and the implementation effect of the invention is simulated with the following examples.

1. Basic Data

The target route of this study is situated in Nanshan District, Shenzhen, starting from the intersection of Industrial 8th Road and Houhai Road and ending at the intersection of Qiaocheng East Road and Baishi Road. We use the actual data of all taxis on the road within two hours from 7:30 to 9:30 between June 9^{th} and 13^{th} in 2014.

Firstly, the research route was divided into 397 road sections, with each section of 25 meters. Then, according to the road sections and time periods to be studied, the GPS data collected from taxis are screened, corrected, and matched. Then, the average speed and the rate of all occupied taxis on each road section can be calculated. Finally, according to the geographic information data of the road network, the number of buildings, banks, hotels, pharmacies, parking lots, supermarkets, restaurants, bus stops, and schools within the range of 500 meters around the research road section will be counted. In addition, the distance from the nearest school, the distance from the nearest intersection, the distance from the nearest bus stop, and the speed limit are also counted.

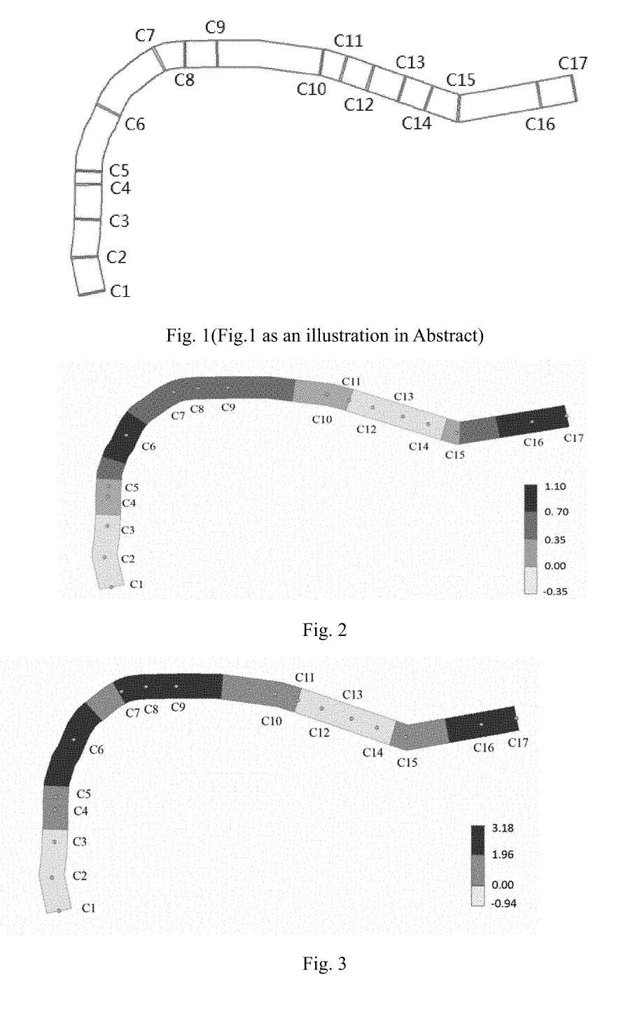

Considering the interaction between intersection types and urban built environment, it is necessary to deal with the intersection type of the research route. The research route contains a total of 17 intersections. The intersection names are shown in table 2 and the location of the intersections are shown in FIG. 1.

TABLE 2
Intersection name

| Intersection | |
|---|---|
| number | Intersection name |
| C1 | Intersection of Industrial |
| | 8^{th} Road and Houhai |
| | Road |
| C2 | Intersection of Dongbin |
| | Road and Houhai Road |
| C3 | Intersection of Dengliang |
| | Road and Houhai Road |
| C4 | Intersection of Chuangye |
| | Road and Houhai Road |
| C5 | Intersection of Haide 1st |
| | Road and Houhai Road |
| C6 | Intersection of Xuefu |
| | Road and Houhai Road |
| C7 | Intersection of Gangyuan |
| | Road and Baishi Road |
| C8 | Intersection of South |
| | Keyuan Road and Baishi |
| | Road |
| C9 | Intersection of South Keji |
| | Road and Baishi Road |
| C10 | Intersection of East Shahe Road |
| | and Baishi Road |
| C11 | Intersection of Shizhou Middle |
| | Road, Shenwan 1^{st} Road, and |
| | Baishi Road |
| C12 | Intersection of Hongshu Street, |
| | Shenwan 2^{ed} Road, and Baishi |
| | Road |
| C13 | Intersection of Shenwan 3^{rd} |
| | Road and Baishi Road |
| C14 | Intersection of Shenwan 4^{th} |
| | Road and Baishi Road |
| C15 | Intersection of Shenwan 5^{th} |
| | Road and Baishi Road |
| C16 | Intersection of Yuntian Road, |
| | Haiyuan 1^{st} Road, and Baishi |
| | Road |
| C17 | Intersection of East Qiaocheng |
| | Road and Baishi Road |

According to the number of imported lanes, whether there is a left-turn lane, and whether the left-turn lane is independent, all intersections on the research route are divided into four categories. Because the variables of intersection type cannot be quantitatively measured as variables such as the number of parking lots, the number of bus stops, and the rate of occupied taxi, therefore, it is necessary to specifically “quantify” its effects on road travel time by introducing “dummy variables”. In order to avoid “dummy variable trap” (multi-collinearity problem), in this case, intersection type 4 is used as a reference item, and intersection type 1, type 2, and type 3 are set as dummy variables. The classification method of the specific intersection type is shown in Table 3 and the setting of dummy variable is shown in Table 4.

TABLE 3
The classification method of intersection types

| Intersection | |
|---|---|
| types | Features |
| Type 1 | The number of entrance lanes does not exceed four, and |
| | there are independent left turn lanes |
| Type 2 | The number of entrance lanes does not exceed four, and |
| | there are left turn lanes but they are not independent |
| Type 3 | The number of entrance lanes does not exceed four, and |
| | there is no left turn lane |
| Type 4 | The number of entrance lanes exceeds four, and there |
| | are independent left turn lanes |

TABLE 4
Setting of dummy variables

| Intersection | | | |
|---|---|---|---|
| types | D1 | D2 | D3 |
| Type 1 | 1 | 0 | 0 |
| Type 2 | 0 | 1 | 0 |
| Type 3 | 0 | 0 | 1 |

2. Results of Global Regression Analysis with Cross Terms

The basic data are brought into the global model proposed in the technical scheme of the invention, and multivariate linear regression is carried out with SPSS. The results are shown in table 5. When the absolute value of t of each variable is greater than 1.96, indicating that the variable is significant, it is selected to be included in table 5.

TABLE 5
Results of multivariate linear regression model

| | | Standardization | | P |
|---|---|---|---|---|
| Variable | Coefficient | coefficient | t value | value |
| Constant | −83.099 | — | −4.101 | 0.000 |
| Number of parking lots | 2.245 | 0.676 | 2.081 | 0.038 |
| (a) | | | | |
| Number of bus stops (b) | −1.881 | −1.019 | −4.218 | 0.000 |
| Rate of occupied taxi (c) | 32.484 | 0.378 | 4.836 | 0.000 |
| Distance from the nearest | −0.033 | −0.566 | −2.521 | 0.012 |
| school (d) | | | | |
| Distance from the nearest | 0.033 | 0.329 | 3.303 | 0.001 |
| intersection (e) | | | | |
| Speed limit (f) | 2.102 | 0.639 | 5.372 | 0.000 |
| Dummy | | | | |
| Intersection type 1 (D1) | 205.796 | 6.172 | 3.336 | 0.001 |
| Intersection type 2 (D2) | 240.479 | 5.108 | 3.637 | 0.000 |
| Interaction term | | | | |
| a × D1 | −5.465 | −1.424 | −3.745 | 0.000 |
| b × D1 | 2.403 | 1.571 | 4.397 | 0.000 |
| b × D2 | 2.910 | 0.652 | 2.726 | 0.007 |
| b × D3 | 2.604 | 0.525 | 3.027 | 0.003 |
| c × D1 | −27.627 | −0.504 | −3.446 | 0.001 |
| c × D3 | −24.866 | −0.355 | −2.509 | 0.013 |
| d × D1 | 0.034 | 0.489 | 2.318 | 0.021 |
| e × D1 | 0.045 | 0.390 | 3.522 | 0.000 |
| e × D3 | 0.044 | 0.223 | 2.579 | 0.010 |
| f × D1 | −3.823 | −6.528 | −3.691 | 0.000 |
| f × D2 | −5.445 | −6.052 | −4.007 | 0.000 |
| F value | 13.805 | | | |
| R_{adj}² | 0.648 | | | |

Analysis: The F value of the model estimation result is 13.805. Given a significant level α=0.05, there is F>F_{0.05}(58,338), which indicates that the null hypothesis is rejected. Therefore, at least one coefficient of the independent variables is significantly different from 0, and the linear relationship of the model is significant at 95% confidence level. In the model result, R_{adj}² is 0.648, indicating that independent variables in the model can explain 64.8% changes in the average speed of the road sections.

It can be seen from Table 5 that intersection Type 1 and intersection Type 2 are positively correlated with the average speed of the road sections, while intersection Type 3 is excluded because of collinearity. This indicates that intersection Type 2 has a dependent left turn lane, intersection Type 3 has no left turn lane, and there is no difference between intersection Type 2 and intersection Type 3 in the effect of the left turn lane. When there is no exclusive left turn lane at the intersection, the left turn cars are interfered with the straight-ahead vehicles, resulting in intersection Type 2 being similar to intersection Type 3. In addition, Table 5 also suggests that the number of parking lots, the distance from the nearest intersection, the speed limit, and the rate of occupied taxi are positively correlated with the average speed of the road sections, while the number of bus stops and the distance from the nearest school are negatively correlated with the average speed of the road sections.

Taking intersection Type 4 as a reference item, when the nearest intersection to the road section is Type 1, the number of parking lots, the number of bus stops, the distance from the nearest school, the distance from the nearest intersection, the rate of occupied taxi, and the speed limit have a significantly different impact on the average speed of the road sections; When the nearest intersection is Type 2, the number of bus stops and the speed limit have a significantly different impact on the average speed of the road sections; When the nearest intersection is Type 3, the number of bus stops, the distance from the nearest intersection, and the rate of occupied taxi have a significantly different impact on the average speed of the road sections. This reveals that the influence of urban built environment on the average speed of the road sections is not the same across the entire research route when the type of the nearest intersection to the road section is different, and such impacts have spatial heterogeneity. In the global regression model, the average impact of urban built environment attributes on the entire regional road sections is estimated, ignoring the spatial heterogeneity of different regional road sections. Therefore, it is necessary to apply the spatial local model-GWR to explore the influencing factors of the average speed of the different road sections and its spatial distribution characteristics.

3. Analysis Results of Spatial Local Model

In the global regression results, the number of parking lots, the number of bus stops, the rate of occupied taxi, the distance from the nearest school, the distance from the nearest intersection, and the speed limit were selected as independent variables.

GWR 4.0 software package is used to estimate the GWR model. The results are the corresponding regression coefficients for each independent variable and the t values of 397 road sections. Moreover, the minimum value, first quartile value, median, mean, third quantile value, and maximum value of the regression coefficient and the t value for each independent variable are shown in Table 6 and Table 7, respectively.

TABLE 6
Regression coefficient estimation results of independent variables of the GWR model

| | Minimum | First | | | Third | Maximum |
|---|---|---|---|---|---|---|
| Variable | value | quantile | Median | mean | quantile | value |
| Constant | −121.072 | −13.914 | 16.439 | −0.006 | 31.870 | 75.133 |
| Number of parking lots | −4.928 | −2.700 | −1.540 | −1.581 | −0.450 | 1.747 |
| Number of bus stops | −0.347 | −0.042 | 0.394 | 0.332 | 0.647 | 1.093 |
| Rate of occupied taxi | −1.111 | 4.816 | 10.288 | 9.521 | 15.067 | 19.033 |
| Distance from the | −0.023 | −0.012 | 0.005 | 0.007 | 0.030 | 0.038 |
| nearest school | | | | | | |
| Distance from the | 0.039 | 0.049 | 0.068 | 0.063 | 0.072 | 0.087 |
| nearest intersection | | | | | | |
| Speed limit | −0.861 | −0.259 | −0.050 | 0.300 | 0.686 | 2.329 |

TABLE 7
t value estimation results of independent variables of the GWR model

| | Mini- | | | | | |
|---|---|---|---|---|---|---|
| | mum | First | | | Third | Maximum |
| Variable | value | quantile | Median | mean | quantile | value |
| Constant | −4.021 | −0.496 | 0.475 | 0.164 | 1.397 | 2.913 |
| Number of | −3.579 | −2.864 | −1.737 | −1.691 | −1.079 | 1.683 |
| parking lots | | | | | | |
| Number of | −0.939 | −0.191 | 1.458 | 1.176 | 2.186 | 3.177 |
| bus stops | | | | | | |
| Rate of | −0.191 | 0.811 | 1.534 | 1.466 | 2.384 | 2.757 |
| occupied taxi | | | | | | |
| Distance | −2.689 | −1.468 | 0.989 | 0.287 | 1.987 | 2.783 |
| from the | | | | | | |
| nearest | | | | | | |
| school | | | | | | |
| Distance | 2.963 | 5.041 | 7.762 | 7.083 | 8.457 | 11.614 |
| from the | | | | | | |
| nearest | | | | | | |
| intersection | | | | | | |
| Speed limit | −1.374 | −0.647 | −0.098 | 0.518 | 1.358 | 4.623 |

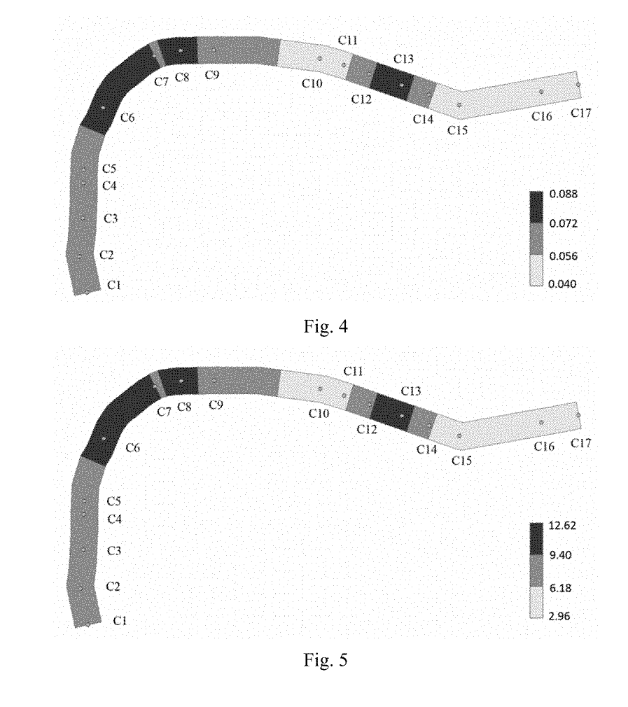

It can be seen from Table 6 and Table 7 that the same independent variable has different impacts on the average speed of different road sections. Specifically, some independent variables are positively correlated with the average speed on some road sections while are negatively correlated on other road sections. Meanwhile, the correlation was significant on some roads, but not on others. According to the results of spatial local model, the coefficients and t values of independent variables with different built environment attributes can be expressed by spatial distribution diagram. In this case, the spatial distribution results of the regression coefficient and the t value of the number of bus stops and the distance from the nearest intersection are given. FIG. 2 and FIG. 3 respectively show the spatial distribution of regression coefficient and t value of the number of bus stops. FIG. 4 and FIG. 5 respectively show the spatial distribution of the regression coefficient and the t value of the distance from the nearest intersection.

It can be seen from FIG. 2 and FIG. 3 that the number of bus stops has a positive correlation with the average speed of the road sections between the intersections 5 and 6, between intersection 7 and 9, and between intersection 16 and 17, which indicates that the road travel time is sensitive to the number of bus stops in these three road sections, and the more bus stops, the shorter the road travel time. This is because, firstly, there are exclusive bus lanes on the research route, and the time period of the collected taxi GPS data is during the service time (7:30-9:30) of the exclusive bus lanes. Therefore, although there are many bus stops on these road sections, bus parking does not have a negative impact on the speed of the social vehicles due to the coordination of the exclusive bus lanes and the harbor-shaped bus stops. Secondly, the more bus stops there are, the higher the probability of the passengers traveling by bus, and the lower the probability of the passengers taking a taxi. Correspondingly, the possibility for taxis decelerating to carry passengers is lower. Therefore, the average speed of the road sections will be higher when taxi data is used to calculate the average speed of the whole road section.

It can be seen from FIG. 4 and FIG. 5 that the distance from the nearest intersection is positively correlated with the average speed on the whole research route, but the coefficients of different road sections are different. This shows that the distance from the nearest intersection has a significant impact on the average speed of the road sections. Specifically, the shorter the distance from the nearest intersection, the lower the average speed of the road sections, and the longer the road travel time. By comparing the nearest intersection type of each road section, it is found that if the nearest intersection is Type 1 or Type 4, the regression coefficient is relatively large, while if the nearest intersection is Type 2 or Type 3, the regression coefficient is relatively small. Intersection types 1 and 4 have independent left turn lanes. This indicates that whether there are left turn lanes has a great impact on the average speed of the road sections. Under the same conditions of other factors, the average speed of the road section with an independent left turn lane at the nearest intersection is relatively faster. Therefore, on the urban main road, if conditions permit, the left-turn dedicated lane should be set as far as possible at the intersection, which can not only ensure the safety of the intersections and the efficiency of the left-turn lanes, but also reduce the road travel time.

We claim:

1. A method to quantitatively analyze the effects of urban built environment on road travel time, characterized in that the steps are as follows:
1) Basic data
The selected research road which 8 kilometers or more is divided into small road sections, with each road section of 20 to 30 meters;
(1) Data extraction of average speed of road section and the rate of occupied taxi
According to the road sections and time periods to be studied, the GPS data of the collected taxis are filtered, corrected, and matched; The GPS data of the taxis containing the speed and passenger status of each road section are obtained, which is recorded as table a; Then, according to the taxi GPS data in Table a, we can calculate the average speed and passenger ratio of all taxis in each section, that is, the ratio of number of taxis with passengers to the total number of taxis;
(2) Extraction of built environmental attributes of road sections
Based on the geographic information data of the road network, firstly, the number of buildings, banks, hotels, pharmacies, parking lots, supermarkets, restaurants, bus stations, and schools within 500 meters around the road section is statistically studied; Then, the distance from the nearest school, the nearest intersection, and the nearest bus stop is counted; Finally, the speed limit of each road section is counted;
(3) Classification of road intersection types
All intersections on the study road are independently classified into n types according to the number of imported lanes, whether there is a left-turn lane, and whether the left-turn lane is independent, n>=2; Then the last type of intersection n is used as the reference item, and the remaining n−1 types of intersections are set to “dummy variables”, as shown in Table 1:
TABLE 1
Setting of the intersection type dummy variables

| Intersection types | D₁ | D₂ | . . . | Dₙ₋₁ |
|---|---|---|---|---|
| Type 1 | 1 | 0 | . . . | 0 |
| Type 2 | 0 | 1 | . . . | 0 |
| . . . | . . . | . . . | . . . | . . . |
| Type n − 1 | 0 | 0 | . . . | 1 |

2) Global regression analysis with cross terms
In the global regression analysis, we take the average speed of each road section as the dependent variable, the built environment attribute of the road section as the key independent variable, and the virtual intersection of the nearest intersection type of the road section as the adjustment variable; Meanwhile, we consider the interaction between the key independent variables and the adjustment variables; The specific model structure is as follows,
$$S = {β}_{o} + {\sum }_{k = 1}^{14} {β}_{k} {χ}_{k} + {\sum }_{p = 1}^{n - 1} {η}_{p} {D}_{p} + {\sum }_{k = 1}^{14} {\sum }_{p = 1}^{n - 1} {λ}_{kp} {χ}_{k} {D}_{p} + ɛ$$
where S represents the average speed of the road section; βₒ is the regression constant; [symbol] ₁, [symbol] ₂, . . . , [symbol] ₁₄ respectively indicate the number of buildings, the number of banks, the number of hotels, the number of pharmacies, the number of parking lots, the number of supermarkets, the number of restaurants, the number of bus stops, the rate of occupied taxi, the number of schools, the distance from the nearest school, the distance from the nearest intersection, the distance from the nearest bus stop, and the speed limit, a total of 14 key independent variables; β₁, β₂, . . . , β₁₄ represent the regression coefficients corresponding to [symbol] ₁, [symbol] ₂, . . . , [symbol] ₁₄; D₁, D₂, . . . , Dₙ₋₁ represent virtual variables of n−1 intersection types respectively; η₁, η₂, . . . , ηₙ₋₁ represent the regression coefficients corresponding to D₁, D₂, . . . , Dₙ₋₁; λₖₚ is the interaction coefficient of the built environment attribute and virtual variable of the intersection type; ε is a random error term;
Through global regression analysis, the key independent variables which significantly affect the road travel time can be obtained, and the existence of spatial heterogeneity can be proved; Therefore, the local model needs to be used for further quantitative analysis;
3) Local model for spatial analysis
The key independent variables which significantly affect the road travel time and obtained from the global regression analysis, are brought into the local model, namely the geographically weighted regression model; The specific model structure is as follows,
$${S}_{i} = {β}_{o} ( {u}_{i} , {v}_{i} ) + {\sum }_{k = 1}^{m} {β}_{k} ( {u}_{i} , {v}_{i} ) {x}_{ik} + {ɛ}_{i}$$
where Sᵢ means the average speed of road section i; ( [symbol] ᵢ, [symbol] ᵢ) is the coordinate of road section i; βₒ( [symbol] ᵢ, [symbol] ᵢ) is a constant of road section i; [symbol] ₖ represents the [symbol] ^{th} independent variable associated with road section i; βₖ( [symbol] ᵢ, [symbol] ᵢ) is the regression coefficient corresponding to [symbol] ₖ; m is the number of independent variables which are statistically significant in the global regression model; εᵢ is the random error of road section i;
The local model considers the spatial heterogeneity of the influence of urban built environment attributes on road travel time in different geographical locations, and studies the phenomenon and causes of this spatial heterogeneity from a quantitative perspective, thus revealing the inherent relationship between urban built environment and road travel time.
